(19) United States
(12) Patent Application Publication
(10) Pub. No.: US 2026/0329161 A1
(43) Pub. Date: Oct. 22, 2026

(54) DEVICE AND METHOD FOR CREATING LIGHTING

(71) Applicant: ARNE WEISS, Bremen (DE)

(72) Inventor: ARNE WEISS, Bremen (DE)

(21) Appl. No.: 19/633,371

(22) Filed: Mar. 30, 2026

Related U.S. Application Data
(63) Continuation of application No. 18/580,294, filed on Jul. 18, 2022, now abandoned.

(30) Foreign Application Priority Data
Jul. 18, 2021 (DE) 10 2021 118 616.5

(51) Int. Cl. G03B 21/58; G03B 15/06; G03B 15/10; G03B 21/20

(52) U.S. Cl. CPC G03B 21/58; G03B 15/06; G03B 15/10; G03B 21/206

(57) ABSTRACT

The invention relates to a device for creating lighting of an object, comprising at least one strip-shaped projection surface and at least one light element for lighting the projection surface. The projection surface is movably arranged, and the device comprises at least one movement unit (28) for moving the projection surface. The device also comprises a control unit, the control unit being designed to control the light element in synchrony with a movement of the projection surface.

### CROSS-REFERENCE TO RELATED APPLICATIONS

This application claims priority to U.S. application Ser. No. 18/580,294, filed Jan. 18, 2024, which is the National Stage entry of International Application No. PCT/EP2022/070008, filed Jul. 18, 2022, which claims priority to Germany Patent Application No. 10 2021 118 616.5, filed Jul. 18, 2021, the content of which are herein incorporated by reference in its entirety.

### BACKGROUND

The requirement to photograph an object as if it were standing in a different environment is well known in the state of the art. This is typically achieved with large LED surfaces. For example, EP 1 393 124 B1 discloses a large light surface that is used to generate the desired illumination of an object to be photographed. However, this has many disadvantages, for example that the system is difficult to adapt to different individual lighting situations and that the system is very cost-intensive, especially when it comes to large objects to be illuminated.

### SUMMARY

The present invention is based on the task of improving a device and a method for generating illumination of an object in such a way that objects can be realistically illuminated in an effective, simple and inexpensive manner.

The aforementioned problem is solved by a device for generating illumination of an object, which comprises at least one strip-shaped projection surface. Preferably, the device comprises exactly one strip-shaped projection surface. Furthermore, the device can comprise several, for example two, three or four projection surfaces. The at least one projection surface can be made of film, Plexiglas or silicone. The width of the projection surface is in particular less than 20 %, most preferably less than 5%, of the length of the projection element.

The device also comprises at least one light element for illuminating the projection surface. The projection surface is movably arranged, whereby the device for moving the projection surface has at least one movement device. Furthermore, the device comprises a control unit, whereby the control unit is designed to control the light element in synchronisation with a movement of the projection surface.

A projection surface is to be understood in particular as a rear projection surface. This means that the at least one lighting element does not illuminate the object directly, but instead illuminates the projection surface on a rear side as seen from the object, so that the object is illuminated with indirect lighting. In other words, the light element illuminates the projection surface in the direction of the object to be illuminated. The projection surface is preferably a diffuse transmitted light element.

The light element can, for example, be at least one projector, in particular a video projector or beamer. This can illuminate the entire projection surface. Furthermore, the device can have several projectors, which preferably illuminate a previously defined section of the projection surface. Furthermore, the light element can be an LED element, which preferably comprises three light-emitting diodes in the colours red, green and blue, most preferably with an additional diode in the colour white. Each light element can be designed as a pixel. Individual LED elements and preferably also the individual light-emitting diodes of these can be controlled individually so that light with different intensities and different colours can be mixed.

In particular, the device has a suspension by means of which the projection surface is suspended. The at least one movement device can also be designed to move the projection surface translationally and/or rotationally. In particular, the at least one movement device comprises a motor.

In particular, the suspension comprises at least one movement device for translational and/or rotational movement of the projection surface. In addition to this movement device, the device can comprise a further movement device, which can preferably move the entire suspension, e.g. translationally. By means of the translatory movement, the moving and illuminated projection surface can, for example, create a light tunnel.

The at least one light element is designed to play back image information and thus illuminate the projection surface. The term “image information” can mean an image, preferably a photo, and/or a video. For example, it can b e a single image, e.g. a real-time recording or an artificially compiled image. Furthermore, an image sequence or a video can be played by means of the at least one light element. This is particularly interesting for panoramic photos.

The control of the at least one light element is synchronised with the movement of the projection surface, preferably in such a way that the impression is created that the object is located in an environment defined by the image information. In particular, the control unit is designed to control the projection surface depending on the position, i.e. depending on a position of the projection surface to be moved. In the case of rotation, the control unit is designed to control the projection surface depending on the angle, whereby full illumination of the object can be achieved by means of the moving and illuminated projection surface. This results in hemispherical illumination that has no tear-off edges. In this way, an “artificial” ambient lighting situation of the object can be displayed on the moving projection surface, the dimensions of which are considerably larger than those of the projection surface.

If the object is photographed using a camera, preferably in a long exposure mode, the optical impression is created that the object is not in its true environment, but in a different, desired environment that can be consciously influenced by selecting the image information. Authentic ambient lighting situations can thus be created, which in turn are then authentically reflected on, for example, a mirrored or reflective surface of the object to be illuminated. Refraction through transparent surfaces of the object is therefore also realistic. The projection surface passes between the object and the camera, although this is not visible on the images of the object due to the preferably regular movement of the projection surface.

While the projection surface is movable, the at least one light element can also be movable or fixed.

The device can also include a camera for taking a photo and/or a video of the object, which preferably records the object by means of long exposure during the movement and illumination of the projection surface.

Preferably, the device comprises a large number of light elements, whereby the light elements are arranged on a carrier. The carrier is preferably also strip-shaped. The light elements can preferably be controlled individually. The carrier can be connected to the projection surface, preferably at a distance from the projection surface, so that the carrier can also be moved together with the projection surface.

The plurality of light elements can preferably be arranged on the carrier in at least one, preferably exactly one, row. Preferably, the plurality of light elements can be arranged in several, preferably two, three or four rows on the carrier, whereby these can be arranged parallel and longitudinally offset to one another. The rows can be offset in relation to each other in such a way that the unlit spaces between the light elements close in the sideways movement. The control unit can be designed to control different rows of light elements with a time delay. In this way, a particularly seamless, in other words gapless, transition can be created between the optical result of differently controlled rows of light elements. The control can be carried out by means of pixel mapping.

A projection surface with an associated support primarily forms an illumination arm, whereby the device can preferably comprise exactly one or more, e.g. two or three, illumination arms.

The projection surface and/or—if light elements are formed on a support—the lighting arm formed in this way can preferably be curved at least in sections. In particular, the projection surface and/or the lighting arm is curved in at least one section, most preferably in a semi-circular shape. Furthermore, the curved design can extend over the entire length of the projection surface and/or the illumination arm. In particular, the object can be arranged at a centre point of the curvature. The curvature does not have to be constant, but can vary in different areas. In addition to at least one curved section, the projection surface and/or the illumination arm can also comprise rectilinear sections or angled sections.

In particular, a projection surface or an illumination arm can span an angular range starting from a position of an object, for example an angular range of at least 45°, preferably at least 90°, more preferably at least 180°, most preferably at least 270°. This preferably applies to all projection surfaces or lighting arms. Thus, a projection surface or a lighting arm can extend from a suspension to one side or to both sides of the object. For example, a counterweight can be arranged on an opposite side of the projection surface or the lighting arm, starting from a suspension, in order to optimise the weight distribution.

The projection surface and/or the lighting arm can be suspended from the suspension in a central area. Furthermore, these can be arranged in an end area at a longitudinal end on a suspension.

Different projection surfaces or different lighting arms can be arranged at a different solid angle, e.g. in relation to the suspension. The projection surfaces or lighting arms can be arranged evenly around the circumference. For example, two projection surfaces or lighting arms with preferably the same curvature can be arranged at an angular distance of at least 90°, most preferably at an angular distance of around 180°.

The projection surface is primarily designed to at least partially cover the object to be illuminated. The same can apply to the support. In particular, the projection surface and/or the lighting arm is arranged in such a way that the object is located in the centre of the curvature, for example the arched or semi-circular shape.

In particular, the device can comprise a support structure that holds the projection surface or the lighting arm, e.g. in addition to the suspension. The support structure can be suspended from the suspension, whereby the projection surface or its carrier can be arranged directly on the support structure and thus indirectly on the suspension. Furthermore, a direct attachment to the suspension can be provided. In particular, the projection surface or a lighting arm can be detachably connected to the support structure, e.g. by means of fastening elements such as cables or straps. This means that the projection surface or the entire lighting arm can be exchanged and thus, for example, the diffusion and/or the type of pixels can be varied.

The support structure can comprise several support arms, whereby, for example, one support arm or two support arms can be assigned to a lighting arm or a projection surface. If a projection surface or a lighting arm extends to both sides of the object, it can also be assigned two support arms, one to each side. The support arms can, for example, extend from the suspension. The support arms can be designed in such a way that they perform the same movement, for example rotation or translation, of the projection surface or the lighting arm. In particular, a support arm moves together with the corresponding projection surface or lighting arm.

As an alternative to a suspended arrangement, the projection surface and/or the lighting arm can be arranged on at least one movement device that is arranged on the floor. For example, the projection surface can span an object from one movement device to another movement device, whereby the movement device is designed to move the projection surface or the lighting arm rotationally and/or translationally. The movement devices can, for example, comprise rollers for movement on the floor. Furthermore, the device can, for example, comprise a rail system on the floor on which the movement devices can move.

Furthermore, the object can be arranged on a presentation surface, for example on the surface of a table, whereby the projection surface or an illumination arm can also be designed to span the object. For example, a support structure can be arranged on the presentation surface, e.g. on the table top of the table. Furthermore, the support structure can be arranged on a table leg and enclose it, for example. Both longitudinal ends of the projection surface or the lighting arm can be attached to the support structure. For example, the support structure can have support arms to which the longitudinal ends can be attached. The projection surface and/or the illumination arm can be rotated and/or swivelled around the object by means of a movement device. For example, the support structure together with the projection surface or the lighting arm can rotate around the longitudinal axis of the table leg.

Furthermore, the device can comprise a holding element on which the object can be placed. The holding element can be designed in such a way that it can also perform a rotational movement, for example by means of a movement device. A device can also comprise at least one lighting arm that is movably arranged on a base, for example a base plate. The lighting arm can be arranged in such a way that it spans the object from the receiving element at an angle of at least 40°. The at least one lighting arm can also span the entire object.

Preferably, the projection surface and/or the illumination arm are flexible so that their curvature can be changed. In other words, the design is not rigid, but the curvature can be changed by external influences.

For example, the device can have a unit for changing the curvature, which can exert a corresponding force on the projection surface or the illumination arm so that their curvature changes. The control unit can be designed to change the curvature during the recording of an image, i.e. during the generation of illumination of the object.

The unit for changing the curvature can, for example, comprise at least one cable pull and/or weights, whereby the control unit can control the unit for changing the curvature in such a way that the curvature changes, for example, depending on the illumination by means of the light elements. The cable pull can comprise a cable and a pulley. One end of the cable can be attached to the suspension, while the other end can be attached to the projection surface or the lighting arm at a suspension point. The suspension point can be fixed in relation to the lighting arm or the projection surface or can be moved over its length, e.g. depending on the force distribution or motorised.

A projection surface or a lighting arm can be retracted and/or folded down. The retraction or folding down can be motorised, for example. For example, the suspension can have a recess through which the projection surface and/or the lighting arm can be moved, in other words retracted, so that its position changes. The recess can be a through opening so that the projection surface or the lighting arm moves through the recess. Different sub-areas of the projection surface and/or the lighting arm can also telescope into one another or be retractable in such a way that they are arranged next to one another. It can be achieved, for example, that at least one end of the projection surface or the lighting arm as a whole is arranged closer to the suspension and therefore does not interfere with an object, a camera or a surface.

The projection surface and/or the lighting arm can have different sections with different degrees of diffusion. Furthermore, the device can have several strip-shaped projection surfaces or several illumination arms which realise different degrees of diffusion and which can be controlled simultaneously or alternately.

For example, projection surfaces with different lighting arms can differ in at least one lens and/or the material used for the projection surface. Furthermore, there may be differences in the type of projection. For example, a different degree of diffusion can result from whether the corresponding projection surface is illuminated by means of a large number of light elements, which are designed as pixels, or whether the projection surface is illuminated by means of at least one projector. There may also be differences with regard to the spatial parameters of the projection. For example, the distance between the light elements and the projection surface can be different and/or the density of the light elements on the projection surface can be different. The light elements used can also differ. For example, individual light elements may comprise RGB and white light, while others may also use UV or infrared light.

The different characteristics can also relate to different light elements on the same lighting arm, for example the light elements of rows arranged next to each other in different ways.

Preferably, each light element can be assigned a section on the projection surface, whereby a light shaft can be formed between the light element and the associated section on the projection surface in order to avoid spillover onto neighbouring sections. The light is mixed or diffused in the light well.

The separation of the different light wells prevents crosstalk, i.e. the illumination of a neighbouring section of the projection surface. As a result, each section is homogeneously illuminated in a mixed pattern and yet sharply delineated from the neighbouring section.

In order to counteract a possibly too sharp separation of the sections that could be visible on an image, a diffusion element can be arranged on the projection surface at least in a border area between two neighbouring sections of the projection surface. Furthermore, the diffusion element can be arranged on the entire surface of the projection surface to be illuminated. The diffusion element can be a silicone layer, for example, which can preferably be between 0.1 mm and 3 mm thick.

Further preferably, the light elements can be arranged movably on the carrier in such a way that they can be moved in a direction opposite to a movement of the carrier. This type of movement of the light elements serves in particular to perform a counter-movement to the movement of the carrier, which it performs together with the projection surface, so that the corresponding light elements can remain at least temporarily at the same location due to the counter-movement. For example, rotating elements, such as rollers or discs, can be arranged on the carrier for this purpose, which can perform a counter-movement to the movement of the carrier, at least for a limited time. Alternatively, the device can comprise a light-guiding structure that forwards the light from the light elements to the projection surface. The light-guiding structure can be a mirror or a light shaft. By changing the position of the light-guiding structure, the aforementioned counter-movement can also be realised. Alternatively, the same effect can also be achieved by several rows of light elements that play back image information in the opposite direction to the direction of movement of the carrier. For example, some of the image information can also be played back with a time delay by a subset of the light elements, whereby the light elements are offset.

Overall, image information played back can remain apparently still in a fixed position, preferably at a fixed angle to the object, so that the height and luminance are increased.

Furthermore, a beam angle of the light elements can be limited, e.g. by corresponding flaps. This can also prevent direct light from shining from the light elements or projection surfaces onto a camera for recording an image or video of the object, for example.

In a further aspect, the present invention relates to a method for generating illumination of an object using an above-mentioned device. In particular, the method comprises playing back image information with the aid of the at least one light element, in particular generating a projection on a projection surface, and moving the projection surface, synchronised with the illumination of the projection surface. In particular, the control is position-or angle-dependent.

Furthermore, light elements that are arranged on a support can be attenuated differently depending on the angle, for example. For example, light elements that are arranged closer to the zenith, e.g. closer to a suspension, can be attenuated more strongly, as they cover a shorter distance during rotation and therefore generate a higher luminance. To prevent this effect, the light elements can have vertical slit-shaped shading, whereby the slit-shaped outlet of the shading narrows the closer they are arranged to the zenith. Different attenuation can also be achieved, for example, by a different degree of diffusion. The light elements can also be controlled with a lower intensity.

The method can involve taking an image and/or video using a camera. For example, a shading element can be placed in front of the camera so that only the view of the object to be photographed and illuminated and its immediate surroundings is unobstructed.

Furthermore, the position of the image information played back can be synchronised to a rotary encoder. The activation of the lighting elements can be controlled by a clock that is regularly synchronised with the rotary encoder. For example, the exact position of a lighting arm or the projection surface can be determined for this purpose. The rotary encoder can continuously, periodically and/or only on request reproduce its position.

Furthermore, the method can be used to determine, for example, that the camera is triggered at a specific position on the projection surface. The exposure time of the camera can also be preset automatically and/or in advance by a user. The exposure time can, for example, be synchronised with the speed of the motor. The method can also include the use of at least one direct light source, such as a spotlight, which illuminates the object directly and therefore does not include a projection surface. The light source can, for example, be adapted to the illumination to be generated by the at least one light element, for example to its colour spectrum, depending on the angle or according to a user's specifications, preferably automatically.

In order to create a closed image, i.e. an image without sharp edges or double and/or unexposed areas, the image information can be played back during a first rotation of the projection surface, whereby the same image information that was faded in at the same position in a previous first rotation is faded out again in a second rotation. In this way, the beginning and end of the image information is blended and sharp edges are avoided.

Furthermore, image information can also be played back with the intervention of a user. The method can also include setting the intensity of the light to be emitted onto the projection surface. In addition, the individual light elements can be controlled in such a way that they only emit the emitted light, for example a respective colour value, for a very short time, comparable to a camera flash.

The individual light elements can be measured in terms of their colour and brightness rendition, whereby the measurement results obtained can be used as correction values in order to achieve uniform brightness and colour rendition. In other words, the specific measurement results obtained can be taken into account when controlling the individual lighting elements. This achieves colour homogeneity of the individual lighting elements and compensates for possible manufacturing tolerances.

### BRIEF DESCRIPTION OF THE DRAWINGS

FIG. 1: a side view of a device according to the invention;

FIG. 2: a side view of a device according to the invention;

FIG. 3: a side view of a device according to the invention;

FIG. 4: a sectional view of a section of FIG. 3;

FIG. 5: a side view of a device according to the invention;

FIG. 6: a side view of a device according to the invention;

FIG. 7: a perspective view of a device according to the invention;

FIG. 8: a perspective view of a device according to the invention;

FIG. 9: a perspective view of a device according to the invention;

FIG. 10: a perspective view of a device according to the invention;

FIG. 11: a side view of a device according to the invention; and

FIG. 12: a side view of a device according to the invention;

### DETAILED DESCRIPTION OF A PREFERRED EMBODIMENT

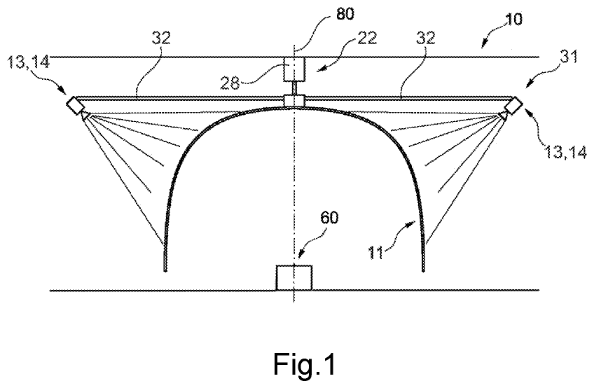

FIG. 1 shows a side view of a device 10 according to the invention, which comprises a strip-shaped projection surface 11.

The device 10 comprises a suspension 22 on which the projection surface 11 is suspended. Furthermore, the device comprises a movement device 28, which is arranged in the suspension 22 and serves to move the projection surface 11 rotationally about an axis of rotation 80.

The projection surface 11 is curved and can span an object 60. The device also has a support structure 31 comprising two support arms 32, which are also arranged on the suspension 22 and can rotate with the projection surface 11.

In FIG. 1, a light element 13 in the form of a projector 14 is arranged on each support arm 32 and is used to project image information onto the projection surface 11. The projection surface 11 is designed as a rear projection surface so that an object 60 is only illuminated with indirect light. The control unit of the device 10 is not shown in FIG. 1 for reasons of clarity. The same applies to the following figures.

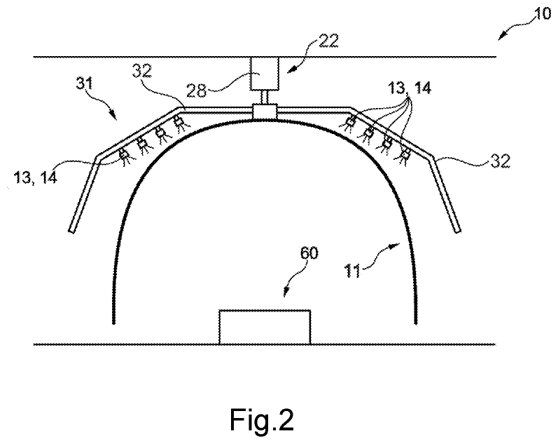

FIG. 2 shows a side view of a further device 10 according to the invention, which is identical to the device 10 of FIG. 1 except for the following differences. While the support device 31 in FIG. 1 comprises continuous straight support arms 32, the support arms 32 in FIG. 2 have straight sections that are angled towards each other. This approximates an arched shape. Several projectors 14 are arranged on the support arms 32 as light elements 13, each of which can only illuminate one section of the projection surface 11.

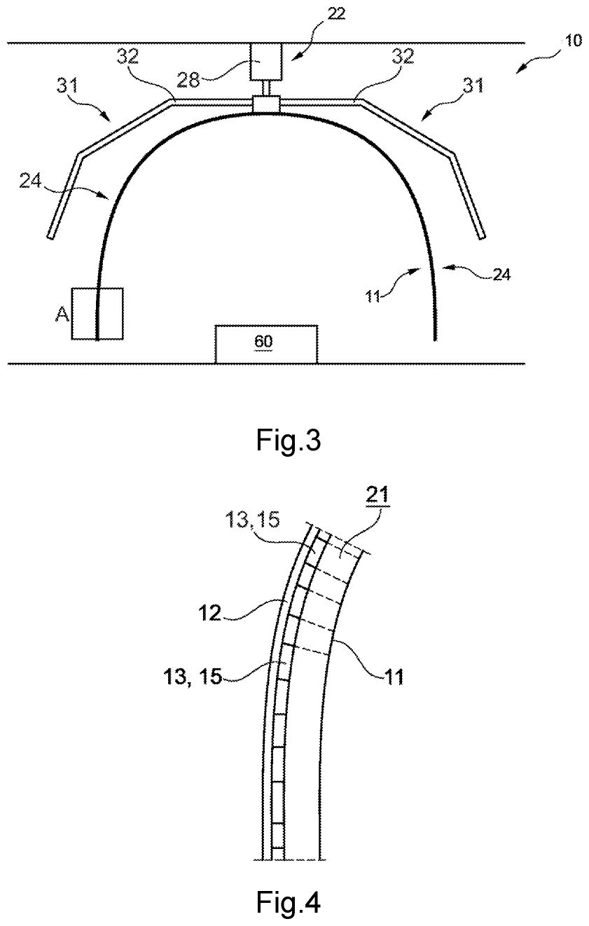

FIG. 3 shows a side view of a further device 10 according to the invention, which is identical to the device 10 of FIG. 2 except for the following differences. No projectors 14 are arranged on the support arms 32, but the device 10 has a carrier 12 on which a plurality of light elements 13, namely LED elements 15, are arranged (see FIG. 4). In particular, an LED element 15 comprises three light-emitting diodes in the colours red, green and blue. Together with the projection surface 11, the support 12 with the light elements 13 forms an illumination arm 24, which spans the object on both sides of the suspension 22. The lighting arm 24 can be detachably fastened to the support structure 31, whereby these fastening elements are not shown in FIG. 3 for better clarity.

The exact formation of the illumination arm can be clearly seen in FIG. 4, which shows a sectional view of section A of FIG. 3. FIG. 4 shows that the projection surface 11 forms the innermost layer starting from the object 60, while the carrier 12 forms the outermost layer. The light elements 13, which are designed as LED elements 15, cast light onto the projection surface 11 so that the object 60 is indirectly illuminated. Light shafts 21 can be provided, which are shown in FIG. 4 by corresponding dashed partitions that prevent neighbouring LED elements 15 from crosstalking.

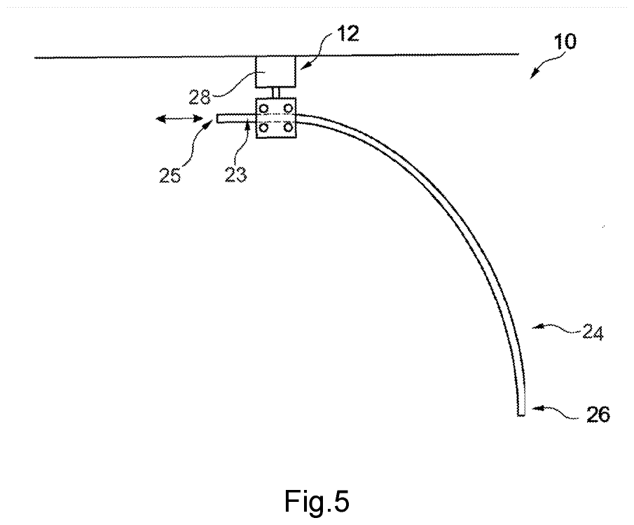

FIG. 5 shows a side view of a further device 10 according to the invention. FIG. 5 shows a lighting arm 24, which is designed to be retractable or extendable in the direction of the arrow. The lighting arm 24 has two longitudinal ends, a first longitudinal end 25 and a second longitudinal end 26. The suspension 22 can have a recess 23 through which the first longitudinal end 25 is guided. Retracting or extending changes the position of the lighting arm at which it hangs from the suspension.

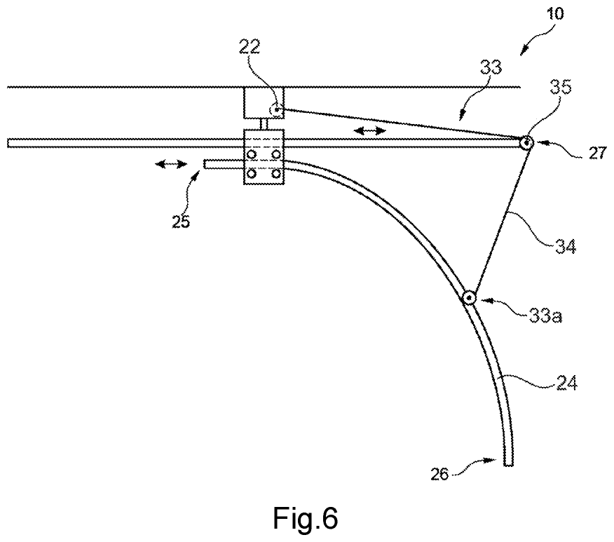

FIG. 6 shows a side view of a device 10 according to the invention, which is analogous to the device 10 according to the invention in FIG. 5, except for the following differences. The lighting arm 24 is flexible so that its curvature can be adjusted. For this purpose, the device 10 has a unit 27 for changing the curvature, which has a cable pull 33 comprising a cable 34 and a deflection pulley 35. The cable 34 is attached at one end to the suspension 22 and has a suspension point 33a on the lighting arm 24 at the other end. This can be fixed in relation to the lighting arm or can move along its length, depending on the force distribution. The lighting arm 24 shown in FIG. 6, on which the cable pull 33 is mounted, can also be moved closer to the suspension 22 in the direction of the arrow, so that a different angle and thus a different force acts on the lighting arm 24.

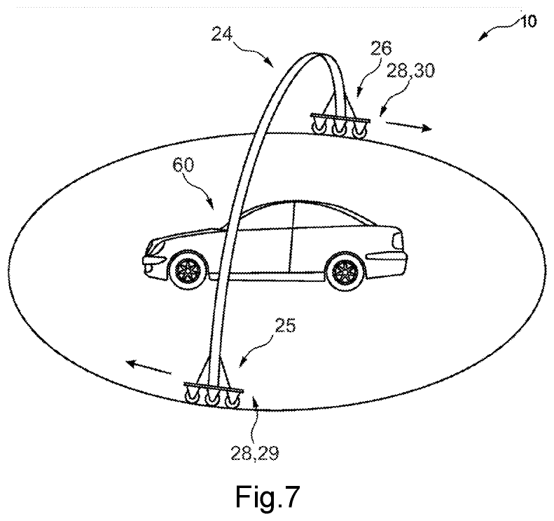

FIG. 7 shows a perspective view of a further device 10 according to the invention, which comprises an illumination arm 24 that spans an object 60 located therein at an angle of approximately 180°. The lighting arm 24 again has a projection surface 11, a support 12 and light elements 13 arranged on the support 12, which are designed as LED elements 15.

Once again, the lighting arm 24 is curved and forms a half-arch. At its first longitudinal end 25, the lighting arm 24 is attached to a first movement device 29, while at its second longitudinal end 26 it is attached to a second movement device 30. The movement devices 28 serve to enable movement in the direction of the arrow. In this way, too, a rotational movement about a central axis, which preferably runs through the object 60, can be realised. The movement devices 28 can move on rails, for example.

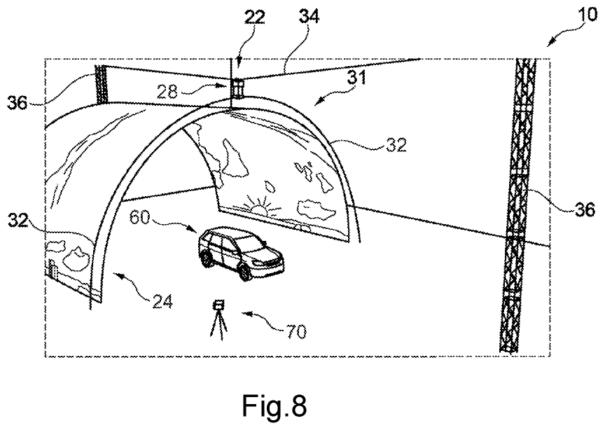

FIG. 8 shows a perspective view of a further device 10 according to the invention comprising an illumination arm 24. The device is identical to the device shown in FIG. 3 except for the following differences. The lighting arm 24 is not attached directly to the suspension 22, but by means of the support structure 31. Furthermore, the support arms 32 are divided into even more rectilinear sections. The suspension 22 is arranged on a cable 34, which is arranged between two posts 36. Thus, the lighting arm 24 can not only be moved rotationally by means of the suspension 22 and the movement device 28 arranged therein, but it can also be moved along the cable in a translational direction by means of a further movement device 28, which is also located in the suspension.

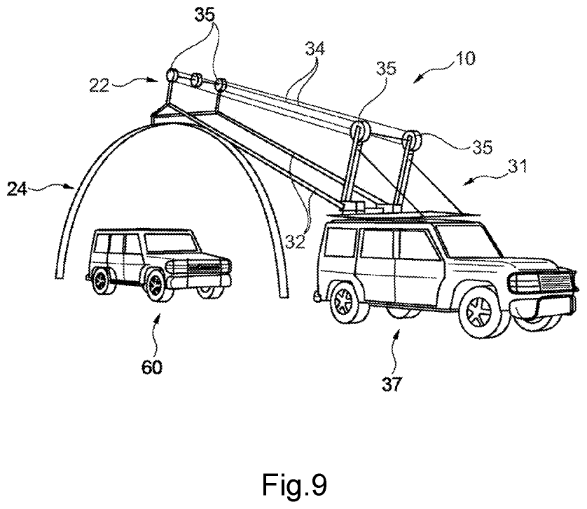

FIG. 8 also shows how a camera 70 can be used to take pictures of the object 60 illuminated by the device 10. Once again, fastening elements between the lighting arm 24 and the support structure 31 are not shown in FIG. 9.

FIG. 9 shows a perspective view of a further device 10 according to the invention. A lighting arm 24 is suspended from a suspension 24. The suspension 22 comprises several deflection pulleys 35 and cables 34, which are, however, arranged on a vehicle 37 via two support arms 32 of a support structure 31. Thus, a movement can take place not only purely rotationally, but also translationally together with the vehicle 37 and the object 60, which may also be a vehicle.

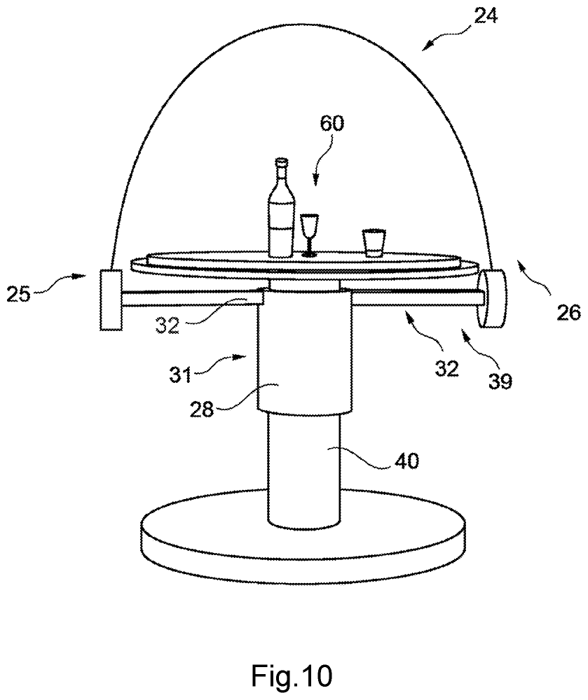

FIG. 10 shows a perspective view of a further device 10 according to the invention, which also has a lighting arm 24 which is arranged on a support structure 31 on a table leg 40 of a table 39. The support structure 31 fully surrounds the table leg 40, while it has two support arms 32, to each of which a longitudinal end, namely a first longitudinal end 25 and a second longitudinal end 26 of the lighting arm 24 are attached.

The device 10 has a movement device 28, which is arranged in the support structure 31, by means of which the support arms 32 and thus also the projection surface 11 or the illumination arm 24 can move rotationally about the longitudinal axis of the table leg and can thus fully illuminate an object 60 on the table.

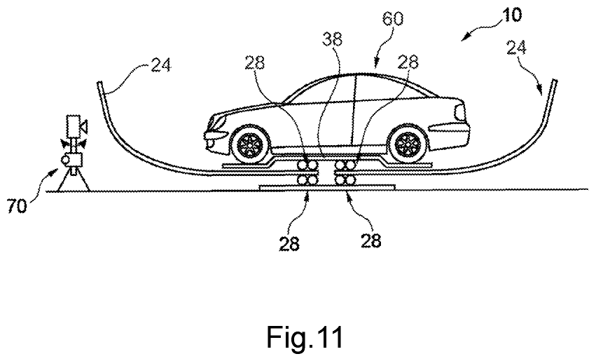

FIG. 11 shows a side view of a further device 10 according to the invention, which also has an illumination arm 24 that is curved at least in sections. Furthermore, the device 10 has two lighting arms 24. These lighting arms 24 each comprise a movement device 28 by means of which they are movable on a base, for example a base plate. The movement devices 28 are shown schematically as rollers.

The device 10 can also comprise a receiving element 38, on which the object 60 can preferably be placed. The receiving element 38 can rotate by means of a further movement device 28. The lighting arms 24 are arranged in such a way that they span the object 60 from the receiving element at an angle of approximately 40°.

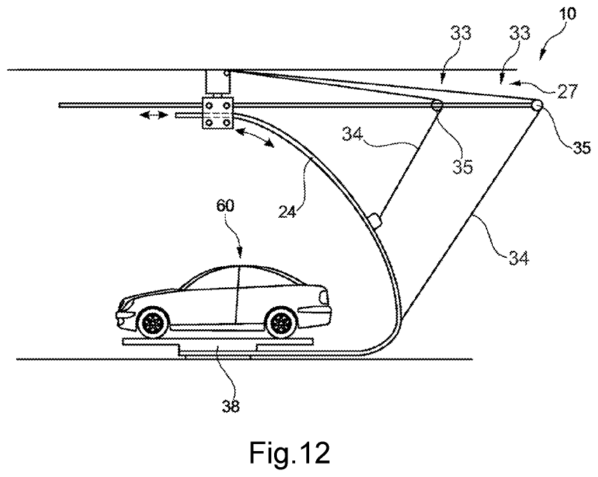

FIG. 12 shows the side view of a further device 10 according to the invention, which is analogous to the device of FIG. 6 except for the following differences. In this case, the unit for changing the curvature 27 comprises two cable pulls 33, each comprising a deflection pulley 35 and a cable 34, which are attached to the central suspension 22. A suspension point 33a of the cable 34 of a cable pull 33 can be moved on the lighting arm 24, while the suspension point of the cable 34 of the other cable pull 33 can be fixed. The lighting arm 24 has different degrees of flexibility along its end. In FIG. 12, the lighting arm 24 extends as far as a mounting element 38 on which the object 60 to be illuminated is arranged and which is designed to rotate the object 60.

### REFERENCE SIGN

10 Device
11 Projection surface
12 Carrier
13 Light element
14 Projector
15 LED element
21 Light well
22 Suspension
23 Recess
24 Lighting arm
25 First longitudinal end
26 Second longitudinal end
27 Unit for curvature change
28 Movement device
29 First movement facility
30 Second movement device
31 Support structure
32 Support arm
33 Cable pull
33a Suspension point
34 Rope
35 Idler pulley
36 Post
37 Vehicle
38 Mounting element
39 Table
40 Table leg
60 Object
70 Camera
80 Axis of rotation

1. A device for generating illumination of an object, wherein the device comprises at least one strip-shaped projection surface, wherein the device comprises at least one light element for illuminating the projection surface, wherein the projection surface is movably arranged, wherein the device comprises at least one movement device for moving the projection surface, wherein the device comprises a control unit, and wherein the control unit is designed to control the light element synchronously with a movement of the projection surface, wherein the device has a suspension, wherein the projection surface is suspended by means of the suspension, wherein the at least one direction of movement is designed to move the projection surface translationally and/or rotationally and, the device comprises a plurality of light elements, the light elements being arranged on a carrier, the light elements being individually controllable, wherein the carrier is connected to the projection surface, so that the carrier is also movably arranged together with the projection surface.

2. The device according to claim 1, wherein
the plurality of light elements are arranged in at least one row on the carrier.

3. The device according to claim 2, wherein
the plurality of light elements are arranged in several, optionally two, rows on the carrier, wherein the rows are arranged parallel and offset to one another in the longitudinal direction.

4. The device according to claim 1, wherein
a projection surface with an associated carrier forms an illumination arm, the device optionally comprising a plurality of illumination arms.

5. The device according to claim 4, wherein
the projection surface and/or the illumination arm are curved at least in sections.

6. The device according to claim 4, wherein
the projection surface and/or the illumination arm are designed to be flexible so that their curvature can be changed.

7. The device according to claim 4, wherein
a projection surface or an illumination arm can be retracted and/or folded down.

8. The device according to claim 4, wherein
the projection surface and/or the illumination arm is designed to at least partially span the object to be illuminated.

9. The device according to claim 4, wherein
the projection surface and/or the illumination arm has sections with different degrees of diffusion.

10. The device according to claim 1, wherein
a section on the projection surface is assigned to each light element, wherein a light shaft is formed between the light element and the associated section on the projection surface in order to avoid cross-talk to neighbouring sections.

11. The device according to claim 1, wherein the projection surface is a rear projection surface.

12. A method for generating illumination of an object, wherein the method uses a device according to claim 1.

13. A method for generating illumination of an object, wherein the method uses a device according to claim 2.

14. A method for generating illumination of an object, wherein the method uses a device according to claim 3.

15. A method for generating illumination of an object, wherein the method uses a device according to claim 4.

16. A method for generating illumination of an object, wherein the method uses a device according to claim 5.

17. A method for generating illumination of an object, wherein the method uses a device according to claim 6.

18. A method for generating illumination of an object, wherein the method uses a device according to claim 7.

19. A method for generating illumination of an object, wherein the method uses a device according to claim 10.
